(19) United States
(12) Patent Application Publication
(10) Pub. No.: US 2014/0147823 A1
(43) Pub. Date: May 29, 2014

(54) System for constructively focusing learner attention guided by a facilitator

(71) Applicant: Lorie Llynn Wolfe, Portage, MI (US)

(72) Inventor: Lorie Llynn Wolfe, Portage, MI (US)

(21) Appl. No.: 13/685,706

(22) Filed: Nov. 27, 2012

(51) Int. Cl. G09B 5/08

(52) U.S. Cl. CPC G09B 5/08
USPC 434/350

(57) ABSTRACT

A system for inciting a body of students to focus on academic topics and produce compositions regarding those topics is disclosed. The system comprises a host system on which an application can execute which navigates students along a virtual path as moderated by a teacher, with students being required to create compositions to be evaluated by the teacher in order to proceed. The system additionally provides communication mechanisms between students and teachers, a peer reviewable gallery of teacher approved compositions, and a mechanism to customize the virtual path to match the initial mental focus of the student group.

### CROSS-REFERENCE TO RELATED APPLICATIONS

This application claims the benefit of provisional patent application Ser. No. 61/563,798, filed Nov. 27, 2011 by the present inventor.

### FEDERALLY SPONSORED RESEARCH

Not applicable

### SEQUENCE LISTING OR PROGRAM

Not applicable

### BACKGROUND-PRIOR ART

The following is a tabulation of some prior art that presently appears relevant:

U.S. Patents:

| Pat. No. | Patentee |
|---|---|
| 7,874,841 | Lycas |
| 7,632,101 | Braunberger |
| 7,343,134 | Ward |
| 7,281,219 | Hamilton |
| 7,257,367 | Etuk et al. |
| 7,197,488 | Higgins |
| 7,155,157 | Kaplan |
| 7,107,311 | Zittrain |
| 7,092,669 | Sakai |
| 7,058,354 | McCormick |
| 7,050,753 | Knutson |
| 7,029,282 | Khan |
| 7,014,467 | Krebs |
| 7,013,325 | Vivian et al. |
| 6,965,752 | Allen |
| 6,965,751 | Koga |

Schools commonly give their teachers the task of educating diverse populations of students in fields such as writing, literacy and communication skills.

With the advent of the internet and distributed computing, systems were designed to create online communication between teachers and students, as well as to provide automated rote management of students through online coursework with deterministic (right or wrong) answers.

These systems neglect to consider the psychological focus of the student, and as such, do not bring forth the full intellectual potential of the student. While demonstrating to a student, for example, that two squared equals four, they neglect to draw the student's mental attention away from more immediate social thoughts, such that the demonstration is not effective.

While there are systems designed to provide personal awareness and growth for developing personal coping methods (Pat. No. 7,874,841, Lycas, Jan. 25, 2011), the application to educational instruction with the creation of a peer viewed open-ended composition has been lacking

### SUMMARY

In accordance with one embodiment a computer server connected to the network hosts an application comprising a means of identifying and communicating with teachers and students, and of navigating the students through a virtual path as evaluated by the teacher, with the the progress evaluation based on each student's composition around the topic associated with the particular point in the virtual path that the student is on. Students may publish teacher approved compositions to a peer-viewable gallery to provide a positive social incentive to focus on the topic matter. The virtual path topics may be organized to match the initial mental focus of the student population, successively becoming less visceral.

### ADVANTAGES

Accordingly several advantages of one or more aspects are as follows: to create a social incentive to produce compositions given a peer viewable gallery, to have evaluations be performed by a teacher who is capable of customizing response to the individual student, to have the ability to follow a path that initially garners student focus, through visceral topic, and through a series of student publications that by themselves would deviate from raw student focus but within the context of a peer published gallery and growing system familiarity, maintains the active student focus.

### DRAWINGS-FIGURES

FIG. 1 illustrates a computer server hosting an instance of the system, including application and storage mechanism, and being related by communication network to students and teacher according to one embodiment of the present invention.

FIG. 2 illustrates a flowchart illustrating steps for student progress through a module in the system and the interaction between student, teacher and system according to one embodiment of the present invention.

FIG. 3 illustrates a virtual path, including topic modules, presented in a sequential manner, according to one embodiment of the present invention.

Drawings - Reference Numerals

| | | | |
|---|---|---|---|
| 1 | students | 2 | teacher or facilitator |
| 3 | server computer running | 4 | communication network or |
| | application | | the internet |
| 5 | client computer running web | 6 | client computer running |
| | browser | | web browser |
| 7 | system main menu upon | 8 | student options |
| | student login | | |
| 9 | gallery of peer produced | 10 | student work interface |
| | compositions | | |
| 11 | student options | 12 | topic examples and supporting |
| | | | material |
| 13 | composition editor | 14 | teacher review interface |
| 15 | teacher may approve or deny | 16 | teacher leaves supporting |
| | composition | | feedback |
| 17 | student approved state | 18 | student with mind focused on |
| | | | visceral topics |
| 19 | initial module topic: art and | 20 | teacher composition approval |
| | passion | | process |
| 21 | module topic: physical self | 22 | teacher composition approval |
| | | | process |
| 23 | module topic: character | 24 | module topic: knowledge |
| 25 | module topic: fear | 26 | module topic: truth |
| 27 | module topic: idea | 28 | final student focused state |

### DETAILED DESCRIPTION

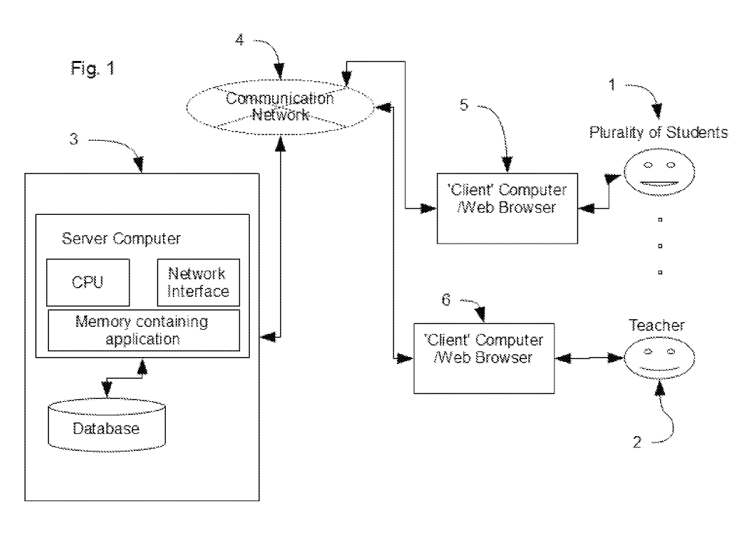

### FIGS. 1, 2, 3—First Embodiment

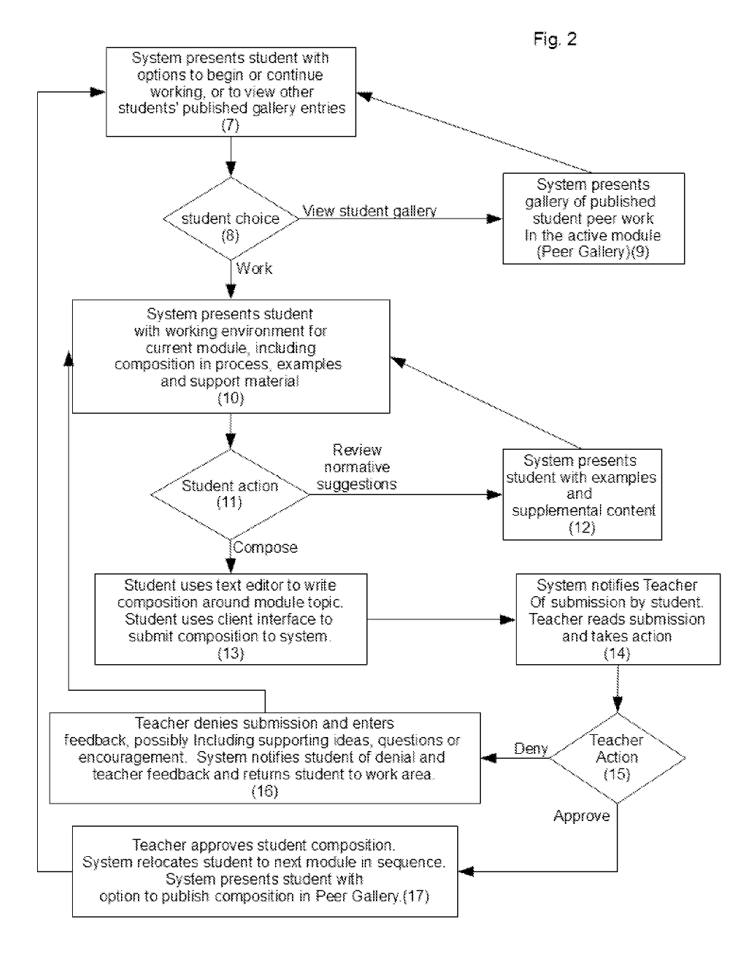

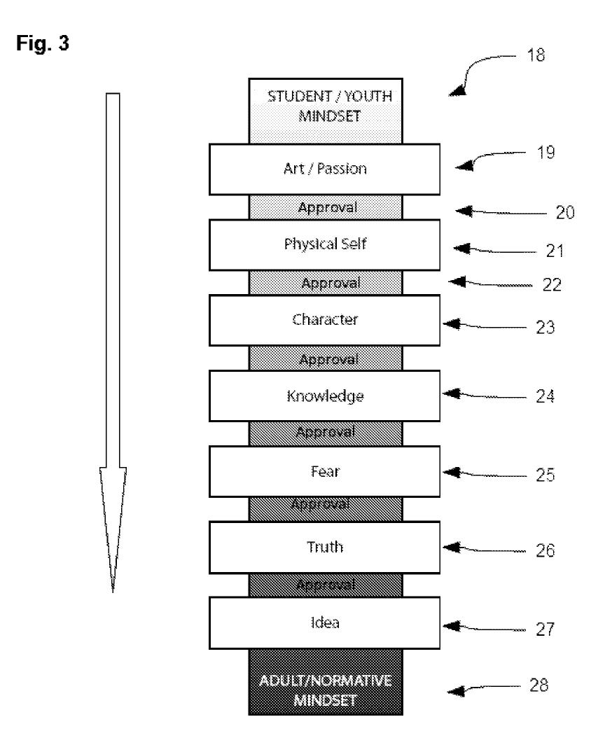

One embodiment of the system is illustrated in FIG. 1 (physical overview), FIG. 2 (module progression flowchart) and FIG. 3 (a virtual path with topics). One or more students 1 and at least one teacher 2 connect to the server 3 via a communication network 4, in this embodiment the internet, and receive display signals from that server and relay signals back to that server with client computers running a web browser 5,6. The server 3 runs the system application, granting the application the ability to store data in a database, including user information, session state, user compositions, and communication history, and to process data with a CPU, and to send and receive data from the communication network via network interface. Each student 1 and the teacher 3 log in to the server with a user name and password and the server stores an internal record identifying that student and teacher's session. Prior to the students 1 logging in, the teacher or the teacher's school has determined the virtual path (FIG. 3) to be followed by the students and the system initially begins each student on the first step in the virtual path 19. Upon logging in, a student 1 is presented with the main menu options 7 which may include the options 8 to begin work on the module topic 10 or to view the peer gallery of teacher approved peer compositions composed in modules that the student is apprised of, if any such compositions yet exist in the peer group 9. If the student chooses to begin working on the module topic, the system presents a working environment 10 to the student in which part of the web browser screen 5 provides multimedia content designed to inspire thought on the topic or other supporting material, with another part of the browser 5 presenting a composition editor and command buttons to save and submit the composition for review. The student types an initial composition around the topic and submits the composition for review 13 wherein the system notifies the teacher 2 via web browser 6 or email client. Teacher accesses teacher composition review interface, reads submission and decides whether the composition sufficiently addresses the module topic 14. If the teacher determines that the student has not sufficiently addressed the module topic or created a composition that the teacher would expect from that student, the teacher denies 16 the submission by pressing a button on the web browser 6 indicating denial and types in feedback for the student. The teacher is additionally presented with a set of prerecorded common denial responses for ease of response in the web browser 6. If the student composition is denied, the system notifies the student of the denial and displays the teacher feedback, and populates the editor in the work interface with the denied composition body for revision. Once the student has revised the composition, the student may resubmit the composition to the teacher 14 repeating this process until the student composition is approved by the teacher upon which the composition is marked as teacher approved and capable of being published in the peer gallery 17. The system then allows the student to optionally publish the approved composition to the peer gallery. The system then apprises the student of the next module in the virtual path and permits the students to see peer gallery compositions in the newly apprised module as well as prior apprised modules when the student views the peer gallery. This process is repeated until the student has completed all of the modules in the virtual path. Once a module has been completed a student may create an additional composition on a module and submit for teacher review, but only teacher approved compositions may be published to the peer gallery.

The virtual path of the first embodiment as illustrated in FIG. 3 begins with a module topic that aligns most closely with the target student group initial focus 18, the module topic which discusses their own Art and Passion 19. Upon submitting a composition on the topic of Art and Passion the teacher may approve 20 the composition at which point the student is apprised of the Physical Self module and assigned to that module as the composition work topic. As the student has been apprised of Art and Passion 19 and approved in it the student may review the peer gallery compositions in the topic of Art and Passion to see what other students in the peer group composed and published. Again in working on the module topic Physical Self 21 the student composes on a topic with many visceral aspects that intrinsically incite composition development. Upon submitting a composition on the topic of the Physical Self and being approved 22, the student is apprised of the Character topic module 23 wherein the nature of character and how it applies to the student is the topic. On composition approval the student is apprised of the Knowledge topic module 24 in which students explore the concept of knowledge and compose on that topic. On the approval of the knowledge topic composition the student is apprised of the Fear topic module 25 in which the student again creates a composition on the concept of fear. On composition approval, the student is apprised of the Truth topic module 26 in which the student creates a composition about what the student considers truth. Upon composition approval the student is apprised of the Idea topic module 27, in which the approved compositions for that student are all presented to the student as part of the supplemental content, and the student create a composition on their idea for themselves based upon their realizations. Upon approval the student has completed the virtual path 28 and may continue to create module specific compositions, review peer gallery submissions and apprised module content as well as their own historically created content.

I claim:

1. A system and method for focusing the attention of a plurality of student users on topics guided by a teacher user comprising:
a) a digital computer server capable of storing, retrieving and processing digital data, and communicating said data between network or internet and an application running on said server, and,
b) one or more digital client computers running web browser or other client interface capable of communicating data through communication network to said server, and capable of displaying data and capturing student user and teacher user input and relaying said input back through network or internet to server such that there is one client interface per user, and,
c) an application running on the server which:
1. provides a mechanism to associate requests entering the server from the network from a particular student or teacher user and to further send out communications to a specific user, and
2. associate a student user with one or more peer groups such that said student users may permissibly view the broadcast communications of other members of said peer group, and
3. provides a plurality of available options to said student, including but not limited to,
3a) the option to begin or continue work on a virtual environment, or virtual path, and,
3b) the option to view a peer gallery in which peer student users have voluntarily listed their teacher approved compositions, and,
3c) the option and mechanisms to communicate with said student's teacher or to review said student's historical teacher communication, and,
4. provides said virtual path, that said student is associated with, and
5. said virtual path being comprised of modules, such that each module focuses on a topic, such that a student may be apprised of said module in a random or through a preferred sequential manner as approved by said teacher, and
5a) each said module providing to student supporting content reflecting said module topic including but not limited to a plurality of multimedia examples of said topic, and,
5b) each said module provides an editing interface displayed on said client computer for said student to produce a composition on said topic and to submit said composition to said server whereat the server may store said composition and take responsive action such as notifying said teacher, and,
6. said teacher is provided with an interface to
6a) review a plurality of student submitted compositions, and,
6b) approve or disapprove the composition work of each student author, combined with supportive feedback to be communicated back to said author on denial, and
7. upon said teacher approving said author composition said author is notified of approval and may optionally be moved to, and apprised of, the next module in said sequence, and
8. upon said teacher denying said composition the server solicits additional feedback from said teacher to communicate to said author along with denial message, and
9. upon denial said author receives said denial notice from server along with said additional teacher feedback, and may continue revising said composition and has the opportunity to resubmit, and,
10. upon teacher approval of said composition said composition is marked as approved, such that author has ability to publish said approved composition in said peer gallery.

2. The system of claim 1 wherein said system provides a fixed sequential virtual path to students.

3. The system of claim 1 wherein the initial topics of the modules of the sequential virtual path of claim 2 resonate most closely with the initial visceral mental focus of said student, engaging personal interest, sequentially becoming less visceral and of broader social and/or academic topic.
